(19) United States
(12) Patent Application Publication
(10) Pub. No.: US 2007/0257841 A1
(43) Pub. Date: Nov. 8, 2007

(54) Method And Apparatus For Localizing A Mobile Transmitter Embodied As An Identification Device, Especially A Vehicle Key

(75) Inventor: Stefan Hermann, Köfering (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SIEMENS AKTIENGESELLSCHAFT, München (DE)

(21) Appl. No.: 11/572,762

(22) PCT Filed: Jul. 20, 2005
(86) PCT No.: PCT/EP05/53523

§ 371 Date: Jan. 26, 2007

(30) Foreign Application Priority Data
Jul. 26, 2004 (DE) 10 2004 036 258.0

(51) Int. Cl. G01S 5/02

(52) U.S. Cl. 342/417; 342/457

(57) ABSTRACT

In a method for locating a mobile transmitter embodied as an identification device (5), especially a vehicle key, relative to a receiver configured as a base station and for recognizing multipath propagation (11b) of a signal (11a) transmitted by the identification device (5), single-path and multipath propagations of the transmitted signal (9, 11a) are detected as receive signals (9, 11b) in the base station by at least two differently oriented reception areas (3a-3d, 27a, 27b), the field intensities of the receive signals (9, 11b) are detected in accordance with the respective reception areas (3a-3d, 27a, 27b), and the receive signal (9) having the greatest field intensity and the reception area (3a-3d, 27a, 27b) associated with the respective receive antenna are determined and are located as the direction of the identification device

### CROSS-REFERENCE TO RELATED APPLICATIONS

This application is a U.S. national stage application of International Application No. PCT/EP2005/053523 filed Jul. 20, 2005, which designates the United States of America, and claims priority to German application number DE 10 2004 036 258.0 filed Jul. 26, 2004, the contents of which are hereby incorporated by reference in their entirety.

### TECHNICAL FIELD

The invention relates to a method and an apparatus for localizing a mobile transmitter embodied as an identification device, especially a vehicle key, relative to a receiver configured as a base station.

### BACKGROUND

Such types of methods and apparatus are used for example in automotive technology, particularly in systems for checking access authorization, used in order to recognize a vehicle key embodied as an identification device as an authorized key. For example, a radio-based access control or locking and starting system can be implemented by this means with the result that access and use (immobilizer) are enabled only upon verification of an authorization.

Conventional access control systems consist of an electronic key, a so-called identification device, which is carried by a person operating the key, and a transmitter and receiver station or base station in the motor vehicle, which detects an approach by an identification device and in response communicates with the latter.

Different types of transmission have hitherto been common, such as for example low-frequency systems in the 125 kHz frequency range or also high-frequency systems in the 433 MHz or 868 MHz frequency range.

In recent times the demand has arisen for extended range with a low idle current requirement. For example, an anti-theft system for a motor vehicle which operates in the microwave or GHz frequency range is proposed for this purpose in DE 199 57 536 A1.

Problems do however result from the comparatively large range associated with low-frequency systems with regard to the assignment of the identification device to the exterior or interior of the motor vehicle.

DE 199 57 536 A1, for example, proposes a method of continuous evaluation of a plurality of successive measurements to determine changes in distance in order to determine the position of the identification device.

The precise position of the identification device can then be determined from the distance values and the associated changes in distance by means of a triangulation calculation. Disadvantageously, determining the position of the identification device for the purposes of monitoring and differentiation between the interior and exterior is an elaborate process.

In addition, multipath propagations of a higher-frequency signal key are problematical since unambiguous localization by ascertaining which side of the vehicle the key is situated on and also measurement of the distance of the key from the vehicle are made more difficult or prevented altogether here.

### SUMMARY

The object of the invention is therefore to set down a method and an apparatus for localizing a mobile transmitter embodied as an identification device, especially a vehicle key, which enables unambiguous localization of the identification device relative to a base station even in the case of multipath propagations.

A method for localizing a mobile transmitter embodied as an identification device relative to a receiver configured as a base station and for recognizing multipath propagations of a signal sent by the identification device, may comprise the step of detecting single-path and multipath propagations of the sent signal as receive signals in the base station by means of at least two differently oriented reception areas such that the field intensities of the receive signals are detected in accordance with the respective reception areas and the receive signal having the greatest field intensity and also the reception area associated with a receive antenna are ascertained and localized as the direction of the identification device.

An apparatus for localizing a mobile transmitter embodied as an identification device relative to a receiver configured as a base station and for recognizing multipath propagations of a signal sent by the identification device, may comprise a base station with a compound receive antenna in order to generate at least two differently oriented reception areas, and/or locally separate antennas having different reception areas, and also an evaluation facility in order to evaluate the received signals in accordance with the reception areas and the field intensity and to recognize multipath propagations.

### BRIEF DESCRIPTION OF THE DRAWINGS

The invention will be described in detail in the following with reference to the embodiments represented in the drawings. In the drawings:

FIG. 1 shows a schematic view of a compound antenna with differently oriented reception areas;

FIG. 2 shows a schematic detail view of a magnetic loop antenna arranged on the vehicle bodywork and

FIG. 3 shows a schematic view of differently oriented reception areas of an apparatus according to the invention in a vehicle.

### DETAILED DESCRIPTION

According to an embodiment, it is advantageously possible, even in the case of multipath propagations occurring, to determine the direction of the identification device as a result of detecting or receiving single-path and multipath propagations of the signal sent by means of at least two differently oriented reception areas and also of [lacuna] the field intensities of the receive signals in accordance with the respective receive antenna. In this situation, the receive signal having the greatest field intensity and also the receive direction associated with the respective receive antenna are ascertained and localized as the direction of the identification device.

In a further embodiment, the result or the localization of the identification device is regarded as invalid as soon as a predetermined number, for example two or three, of multipath propagations of the signal are detected. By this means it is advantageously possible to avoid the situation whereby a plurality of signals of the same frequency cause an errored statement relating to the localization of the identification device resulting from interference, superimposition, fading effects, etc.

According to an embodiment, it is likewise possible—additionally or as a sole criterion for the quality of the result—to regard the localization of the identification device as invalid as soon as a predefined field intensity value for the receive signal of a detected multipath propagation is exceeded. By this means it is advantageously possible to recognize multipath propagations below a predetermined field intensity value (threshold value) as such without the error-free localization of the identification device suffering as a result. According to an embodiment, only when the interfering signals (multipath propagations) exceed a certain threshold value does the danger exist of unambiguous localization of the identification device being made more difficult or even impossible and the result being errored.

In an embodiment, the single-path and multipath propagations of the sent signal are detected by means of at least four differently oriented reception areas. By this means the statement relating to the direction is advantageously refined, whereby for example it is possible to differentiate in the directions left, right, forward and backward. According to an embodiment, in the case of overlapping areas it is even possible to additionally recognize intermediate directions such as forward right, back right, forward left, back left.

In a further embodiment, a receive signal is recognized as a single-path propagation only as of a predetermined threshold value for the field intensity. By this means, it is possible as the sole or an additional criterion for the quality of the result to ignore relatively strong multipath propagations and other disturbances and thus avoid errored localizations of the identification device.

It is naturally desirable for successful localization that the identification device continues to transmit until the desired result (correct localization) has been achieved. This is normally already made possible in the case of known methods by means of a bidirectional communication with request and acknowledgment.

According to an embodiment, in order to generate differently oriented reception areas, the base station has a compound receive antenna, in particular a Vivaldi antenna, which for example is located centrally in the vehicle roof. According to an embodiment, in this situation, the antenna can form a structural unit with the base station or be locally separate from the base station and connected with it electrically. According to an embodiment, in order to evaluate the received signals in accordance with the reception areas and the field intensity and to recognize multipath propagations, the base station also has an evaluation facility. Alternatively or additionally, locally separate antennas, magnetic loop antennas in particular, with differently oriented reception areas or reception cones can also be used as the antenna.

In an embodiment, the antennas are arranged such that their reception areas project through an inner area of an object to be monitored, in particular through the interior of a vehicle, to the outside. By this means, it is advantageously possible to cover an inner area of an object, of a vehicle in particular, in overlapping fashion such that a single-path propagation of a signal from an identification device, which is situated for example in the interior, can be received directly by a plurality of antennas oriented through the interior. In this way an unambiguous, more precise localization of the identification device can be performed, namely in the interior. According to an embodiment, in the case of locally distanced individual antennas, these can for example be arranged on an internal side of a pillar of a vehicle (A, B or C pillar) and/or in the vehicle dashboard and parcel space and with their reception area or cone oriented inwards.

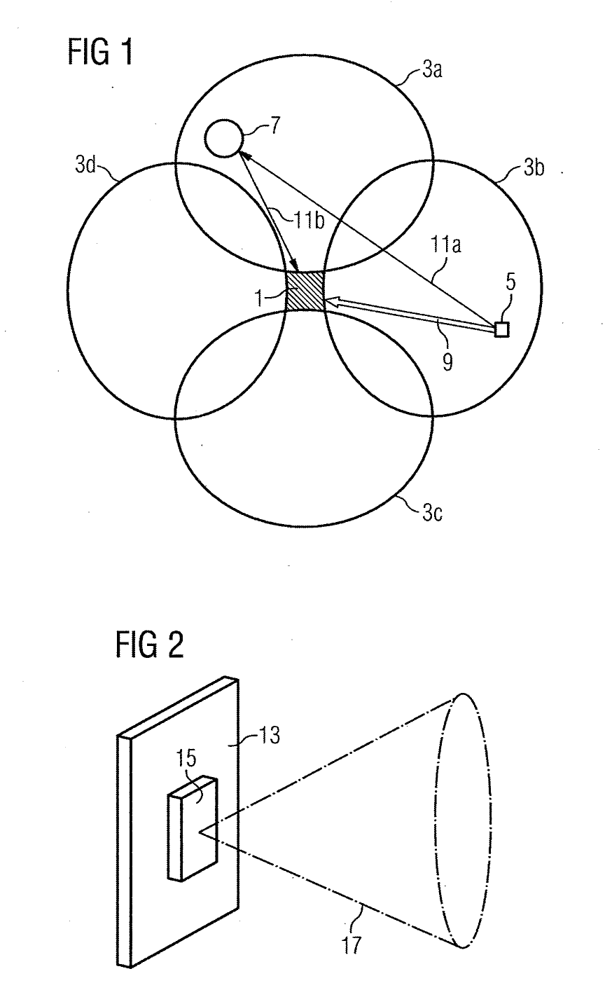

FIG. 1 shows a schematic view of a compound antenna 1, in particular a Vivaldi antenna, from which differently oriented reception areas 3a, 3b, 3c and 3d normally propagate in the form of cones. These cones also propagate out of the drawing plane (obliquely to vertically), such that in the illustration the areas 3a to 3d are to be understood as a straight or oblique conical section of the normally lobar reception areas.

An antenna 1 of this type can be situated for example in a vehicle centered or centrally on the underside of the vehicle roof, such that its cones are directed outwards, whereby these cones can have an oblique downward direction in each case. The view according to FIG. 1 can therefore be regarded as a top view of a vehicle having such an antenna 1, such that the reception area 3b covers the right-hand side of the vehicle, the reception area 3a covers the front side of the vehicle, the area 3c covers the rear side of the vehicle and the area 3d covers the left-hand side of the vehicle which is not represented in more detail in the drawing.

If an identification device or key 5 is now situated in one of the reception areas of the antenna 1, such as the reception area 3b for example, then the antenna 1 receives a single-path propagation 9 of the send signal from the key 5 by a direct path by way of this reception area. Since the send signal from the key 5 also propagates in other directions, the situation can however occur, as represented in FIG. 1, whereby a multipath propagation of the send signal from the key 5 occurs by way of reflecting object 7 likewise situated in a reception area. Walls, other vehicles etc. may be considered as a reflecting object 7 in this situation.

In the case of such a multipath propagation, the signal path is then no longer, as in the case of a single-path propagation, direct from the key 5 to the antenna 1 but takes an indirect route, namely by way of a propagation 11a of the signal to the reflecting object 7 and from the latter by way of a propagation 11b to the antenna 1.

Since differently oriented reception areas exist, it is possible in this situation to detect that one and the same send signal from a key 5 reaches the antenna 1 from different directions. In this situation, the identity of the send signal can for example actually be determined by the fact of “same send frequency” without requiring any further analyses (identifier, signal evaluation, propagation time etc.).

As represented in FIG. 1, in this situation for example a send signal 9 from the key 5 is detected by way of the right-hand reception area 3d and also a further send signal 11b is detected by way of the reception area 3a, in other words the front side of the vehicle.

Accordingly, at this point in time it is already known that at least one multipath propagation of the send signal from the key 5 is taking place.

Since as a consequence of the shorter path the field intensity of a directly received signal (single-path propagation) from the key 5 normally has a higher value than the field intensity of a send signal from the key 5 received by way of a multipath propagation, in this example by using the method according to an embodiment the key 5 can be localized on the right-hand side of the vehicle, namely inside the reception area 3b.

A multipath propagation 11a, 11b, as shown in FIG. 1, can in this situation for example remain out of consideration by virtue of the lower field intensity of the signal 11b.

Following such a localization of the key 5, depending on a successful localization of such a type, further evaluations such as for example the distance of the key 5 can then be determined using known methods, such as propagation time measurement of the signal etc. Depending on the localization and/or further evaluations, actions such as for example unlocking the motor vehicle, releasing the immobilizer etc. can then be controlled.

Instead of or in addition to a compound antenna 1 arranged in the object to be monitored, a vehicle in particular, according to FIG. 1, it is also possible to arrange individual antennas, magnetic loop antennas in particular, in the vehicle. As illustrated in FIG. 2, in an embodiment a loop antenna 15 of such a type is arranged situated on the inside of the vehicle bodywork, such as for example on the vehicle pillars (A, B or C pillar), in the vehicle roof, the vehicle dashboard or the vehicle rear, the parcel shelf in particular.

In this situation, the antenna 15 is for example arranged on the left-hand B pillar on the vehicle interior such that its conical reception area 17 projects through the vehicle interior and covers the right-hand vehicle space. Similarly, an antenna arranged on the inside of the right-hand vehicle pillar can project through the vehicle interior and cover the left-hand side of the vehicle. The front and rear area of the vehicle can then for example be covered by a compound antenna 1, as shown in FIG. 1, or can be covered by corresponding reception cones, likewise projecting through the interior in each case, of further individual antennas arranged in the vehicle dashboard and in the vehicle rear (preferably centrally).

As of a particular frequency of the signal from the key 5, particularly the UHF range, the vehicle pillars do not normally act as reflectors, with the result that no multipath propagations of a send signal from the key 5 can occur by this means.

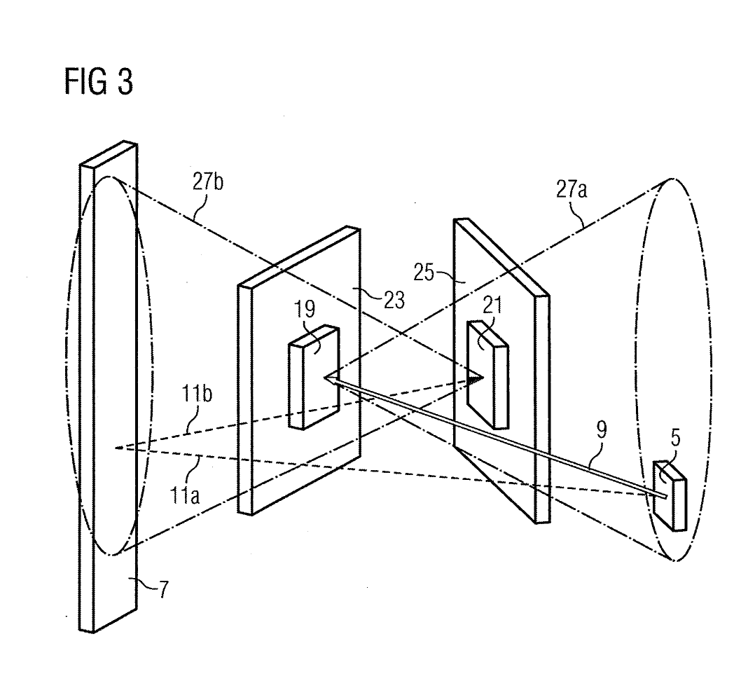

FIG. 3 gives a schematic illustration by way of example of how according to an embodiment a key 5 can be localized by means of two locally distanced antennas 19 and 21, magnetic loop antennas in particular, with differently oriented conical reception areas 27a and 27b. The key 5 is situated—as illustrated—in a reception area 27a of the antenna 19 which is arranged for example on the inside of the left-hand B pillar 23 of a vehicle. As can be seen from FIG. 3, opposite this, in other words in this example on the inside of the right-hand B pillar 25 of a vehicle, is arranged a further antenna 21 whose reception cone 27b, in the same way as the reception cone 27a of the antenna 19, projects through the interior of the vehicle and, whereas the reception area 278a covers the right-hand side of the vehicle, covers the left-hand side of the vehicle situated opposite.

If now, as illustrated in FIG. 3, the key 5 is situated on the right-hand side of the vehicle outside the vehicle, then its directly sent single-path propagated signal 9 will be received only by the antenna 19. If a reflector 7, such as for example a house wall etc., is situated within the reception area 27b then it can happen that a signal 11a traveling from the key 5 to the reflector 7 is reflected at the latter and is received as signal 11b by the antenna 21.

Since this signal 11b has a lower field intensity than the signal 9, this signal can be recognized as a multipath propagation, with the result that the key can be unambiguously localized on the right-hand side of the vehicle by way of its stronger signal 9. As long as the antennas 19 and 21 are each situated on the inside of opposite vehicle pillars, the representation according to FIG. 3 should naturally be interpreted such that the vehicle pillars 23 and 25 are situated parallel to one another. Accordingly, the reception areas are situated in mirror symmetry to the longitudinal vehicle axis lying directly opposite one another in the direction of left-hand and right-hand sides of the vehicle respectively.

However, if the key 5 is situated in the vehicle interior, its send signals will be received by both antennas 19, 21 at approximately equal intensity, with the result that (in this case) two single-path propagations of the send signal from the key will be detected. In this case, a simple localization of the key 5, namely “situated in the vehicle interior”, is possible.

The method according to an embodiment is preferably used as of a frequency of several MHz to for example several GHz, since propagation time measurements can become easier on account of the higher attenuation only as of the VHF and particularly UHF and microwave ranges in the close vicinity of a few meters, for example up to 5, 10 or 15 meters.

In order to increase the security against unauthorized access, a plurality of checks can be provided individually or in any combination. For example, a predefined threshold value can be specified for the field intensity, a send signal not being recognized as a single-path propagation until said field intensity is reached. In addition, a predefined minimum threshold value is possible for the signal field intensity which must be reached for signals to be received at all, with the result that signals having a lower field intensity are regarded from the outset as interference or as irrelevant. Moreover, it is conceivable when detecting a predefined number of multipath propagations, in other words for example when there is just one additional (multipath propagated) signal, to discard the result of the localization and to wait for a newly sent signal.

The invention is naturally not restricted to the embodiment described but can be applied in any desired objects (house door, garage doors, building entries, security zones in buildings etc.) which require monitoring of an access authorization.

What is claimed is:

1. A method for localizing a mobile transmitter embodied as an identification device relative to a receiver configured as a base station and for recognizing multipath propagations of a signal sent by the identification device, the method comprising the step of
detecting single-path and multipath propagations of the sent signal as receive signals in the base station by means of at least two differently oriented reception areas such that
the field intensities of the receive signals are detected in accordance with the respective reception areas and
the receive signal having the greatest field intensity and also the reception area associated with a receive antenna are ascertained and localized as the direction of the identification device.

2. The method according to claim 1, wherein as of a predetermined number of detected multipath propagations of the signal the localization of the identification device is regarded as invalid.

3. The method according to claim 1, wherein as of a predetermined field intensity value of the receive signal of a detected multipath propagation the localization of the identification device is regarded as invalid.

4. The method according to claim 1, wherein the single-path and multipath propagations of the sent signal are detected by means of at least four differently oriented reception areas.

5. The method according to claim 1, wherein a receive signal is not recognized as a single-path propagation until a predetermined threshold value for the field intensity is reached.

6. The method according to claim 1, wherein the identification device is embodied as a vehicle key.

7. An apparatus for localizing a mobile transmitter embodied as an identification device relative to a receiver configured as a base station and for recognizing multipath propagations of a signal sent by the identification device comprising a base station with a compound receive antenna in order to generate at least two differently oriented reception areas, and/or locally separate antennas having different reception areas, and also an evaluation facility in order to evaluate the received signals in accordance with the reception areas and the field intensity and to recognize multipath propagations.

8. The apparatus according to claim 6, wherein the receive antenna is embodied as a Vivaldi antenna.

9. The apparatus according to claim 7, wherein the antennas are arranged such that their reception areas project through an inner area of an object to be monitored, in particular through the interior of a vehicle, to the outside.

10. The apparatus according to claim 8, wherein the interior is embodied as a vehicle interior.

11. A system for localizing a mobile transmitter embodied as an identification device relative to a receiver configured as a base station and for recognizing multipath propagations of a signal sent by the identification device, comprising
means for detecting single-path and multipath propagations of the sent signal as receive signals in the base station by means of at least two differently oriented reception areas such that the field intensities of the receive signals are detected in accordance with the respective reception areas and
the receive signal having the greatest field intensity and also the reception area associated with a receive antenna are ascertained and localized as the direction of the identification device.

12. The system according to claim 11, wherein as of a predetermined number of detected multipath propagations of the signal the localization of the identification device is regarded as invalid.

13. The system according to claim 11, wherein as of a predetermined field intensity value of the receive signal of a detected multipath propagation the localization of the identification device is regarded as invalid.

14. The system according to claim 11, wherein the single-path and multipath propagations of the sent signal are detected by means of at least four differently oriented reception areas.

15. The system according to claim 11, wherein a receive signal is not recognized as a single-path propagation until a predetermined threshold value for the field intensity is reached.

16. The system according to claim 11, wherein the identification device is embodied as a vehicle key.
